(19) United States
(12) Patent Application Publication
(10) Pub. No.: US 2023/0306451 A1
(43) Pub. Date: Sep. 28, 2023

(54) USING MACHINE LEARNING TO IDENTIFY SUBSTITUTIONS AND RECOMMEND PARAMETER CHANGES

(71) Applicant: Focal Systems, Inc., Burlingame, CA (US)

(72) Inventor: Francois Chaubard, Millbrae, CA (US)

(21) Appl. No.: 18/190,903

(22) Filed: Mar. 27, 2023

Related U.S. Application Data
(60) Provisional application No. 63/439,835, filed on Jan. 18, 2023.
(60) Provisional application No. 63/324,523, filed on Mar. 28, 2022.

(51) Int. Cl. G06Q 30/0202; G06Q 10/087

(52) U.S. Cl. CPC G06Q 30/0202; G06Q 10/087

(57) ABSTRACT

A status of each of plural products that are substitutions at each of plural time intervals is determined by inputting the image into a first machine learning (ML) model and receiving as output from the first ML model the status. First data entries comprising the status and a time stamp for each of the products at each of the time intervals are generated. Second data entries comprising a record of sales for each of the products with corresponding timestamps for a time of sale are generated. For a first one of the products, its corresponding entries of the second data entries and a status corresponding to their timestamps of at least a second one the products that is a substitute of the first product are input into a second ML model to receive as output from the second ML model a recommendation pertaining to changing one or more parameters associated with the first product.

### CROSS REFERENCE TO RELATED APPLICATIONS

This application claims the benefit of U.S. Provisional Application No. 63/324,523, filed Mar. 28, 2022, the disclosure of which is hereby incorporated by reference herein in its entirety.

### TECHNICAL FIELD

The disclosure generally relates to the field of machine learning, and more particularly relates to applying machine learning techniques to determine item substitutions and drive a recommendation engine based on substitution determinations and parameters relating to substitutions.

### BACKGROUND

Stores offer products for sale to shoppers who visit the stores. As shoppers purchase the products that are available for sale, store management must continually restock products as shoppers purchase them to ensure the products remain available for purchase, without the products going out of stock on store shelves and therefore avoiding opportunities for making a sale. Numerous challenges arise in ensuring the different products remain in stock or ensuring that the amount of time a product is out of stock is minimized. For example, some challenges may be logistical. The different products may need to be restocked at different rates, and it may be difficult to precisely account for the different rates of restocking the different products during the labor-intensive manual restocking process. As another example, the rate at which a particular item needs to be restocked may change over time. For example, a product may sell at a lower rate during an “off-season” and sell at a much faster rate when that product is “in-season”. If the consumption patterns (e.g., rate of sale) of the product are known and well understood, the restocking rate of the product may be adjusted accordingly, thereby preventing or minimizing the product going out of stock. However, in certain instances, consumption patterns of the product are unknown or hard to predict. It may be desirable to predict when the rate of consumption of a particular product is going to change, so that steps can be taken to prevent or minimize the product going out of stock even with the higher rate of consumption.

Further, vast amounts of data and computational resources may be required to predict changes in consumption rates of different products or to predict if the changes in the consumption rates are due to lack of availability of other products. A better, computationally more efficient approach is desirable.

### SUMMARY

This disclosure pertains to identifying products that are substitutions of each other based on a status (e.g., in stock, low stock, out of stock) of the plurality of products at a plurality of time intervals, and further based on a rate of sale of the products during the time period corresponding to the plurality of time intervals. Techniques disclosed here look to identify whether a demand for a particular product changes based on the status of another product (e.g., Coke cans start selling at a higher rate at a store after Pepsi cans at the store go out of stock). The disclosed embodiments further look to predict what the change in the rate of sales will be for a product that has been identified to be a substitution of another product (e.g., predict how many more Coke cans will sell in an upcoming time period based on Pepsi cans being out of stock). The system proposes generating different recommendations based on the prediction and presenting the recommendations to a user of a store client device. For example, the recommendation may comprise changing a quantity or rate of reorder or restocking of a particular product by a specified amount based on the prediction of increased demand for the particular product during an upcoming time period. As another example, the recommendation may comprise changing an order in which the particular product is restocked on store shelves to account for the predicted faster rate at which the product will be removed from the shelves (as a result of being sold). As another example, the recommendation may be to maintain a status (e.g., out of stock status) for a substitute product for a predetermined upcoming time period.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG. 1 illustrates one embodiment of a system environment including a substitution system that identifies substitutions and manages inventory, in accordance with some embodiments.

FIG. 2 illustrates exemplary modules included in the substitution system, in accordance with some embodiments.

FIGS. 3A-3D illustrate a depiction of time-series image data for identifying products that are substitutions and recommending parameter changes associated with the identified products, in accordance with some embodiments.

FIG. 4 illustrates an exemplary process for managing inventory for products that are substitutions, in accordance with some embodiments.

FIG. 5 is a block diagram illustrating components of an example computer system, in accordance with some embodiments.

### DETAILED DESCRIPTION

### Example System Environment and Architecture

FIG. 1 illustrates a system environment 100 for a substitution system, in accordance with some embodiments. FIG. 1 includes one or more cameras 110, a store client device 150, a network 155, and a substitution system 160. Alternate embodiments may include more, fewer, or different components and the functionality of the illustrated components may be divided between the components differently from how it is described below.

The substitution system 160 is configured to detect a stock status of products within the store based on images received from the cameras 110 and further identify products that are substitutions based, in part, on the detected stock status of the products. That is, the substitution system 160 identifies two or more products that are substitutions of each other (e.g., 12-ounce cans of Coke and Pepsi). The substitution system 160 further manages inventory for the identified products that are substitutions by generating recommendations for store management based on, e.g., a comparison of a rate of sale of a product when its identified substitute product is in stock as compared to a rate of sale of the product when its identified substitute product is out of stock.

Stores, such as grocery stores, include a number of aisles created by rows of shelves on which products are stocked and the location of the products within the store is organized, albeit often loosely, in a predetermined layout known as a planogram. Each camera 110 is associated with a unique camera ID and mounted on a shelf with a predetermined set of products within the camera's field of view known to the substitution system 160 based on the planogram of the store. Each camera 110, therefore, collects image data for a predetermined set of products on opposing shelves for on-shelf inventory tracking and stock detection (including out of stock detection). In one embodiment, the camera 110 is equipped with a motor to cause the camera 110 to pan, for example, from the top left of the opposing shelf to the top right, angle downward, and then pan from left to right again in an iterative manner until it hits the bottom right. Moreover, each camera 110 may, along with one or more images of the opposing shelf unit, send information about the camera 110 to the substitution system 160, such as a unique device ID, battery level, external battery connection, IP address, software version number. Moreover, since store shelves are roughly planar and the camera 110 are often mounted on the other shelf across the aisle and directed as close to normal the tracked shelf, the distance from the top left corner of the tracked product region and the center tracked product region, the camera must have an appropriate depth of field to be able to focus in those areas. Each camera 110 may be equipped with a cellular connectivity modem for communicating directly with a cell tower, for example. In another embodiment, each camera 110 may be equipped with a Wi-Fi chip and connected straight to a pre-existing network. In some embodiments, the camera 110 may be a camera that collects images in backrooms or warehouses, where inventory is stored for future sale or distribution. In some embodiments, a store can also be a warehouse (e.g., Costco).

The store client device 150 (e.g., a desktop computer, mobile device, tablet computer, etc.) receives information about status of products of the store from the substitution system 160 and presents the information to a store associate (e.g., a store owner, manager, or employee). For example, the store client device 150 may present a store associate with information about which products are low in stock or out of stock (e.g., lower than a threshold of stock, such as the quantity being lower than 1), and corresponding timestamps associated with the information. The store client device 150 may also present a map that indicates where, in the store, products associated with the presented information are located. In some embodiments, the store client device 150 presents the images based on which the information of the products is generated and presented. For example, the store client device 150 presents images corresponding to products that are identified as substitutions of each other or products for which a recommendation to change a parameter has been generated. These images may be overlaid with additional markers to convey the information that is detected by the substitution system 160 and that is being presented to store management. For example, the images may include bounding boxes that identify where in the image a product is located, and information regarding what information is being conveyed in the bounding boxes.

The cameras 110 and the store client device 150 can communicate with the substitution system 160 via the network 155, which may comprise any combination of local area and wide area networks employing wired or wireless communication links. In one embodiment, the network 155 uses standard communications technologies and protocols. For example, the network 155 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 155 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 155 may be represented using any format, such as hypertext markup language (HTML) or extensible markup language (XML). In some embodiments, all or some of the communication links of the network 155 may be encrypted. Moreover, the images can be communicated via Bluetooth or radio. For example, each individual camera may be equipped with a cellular connectivity modem that communicates directly with a cell tower. If the modem can transfer data, then the camera can send the image and information directly to the cloud for processing by the substitution system 160. The camera may also send a SMS based alert with the current state of a shelf unit.

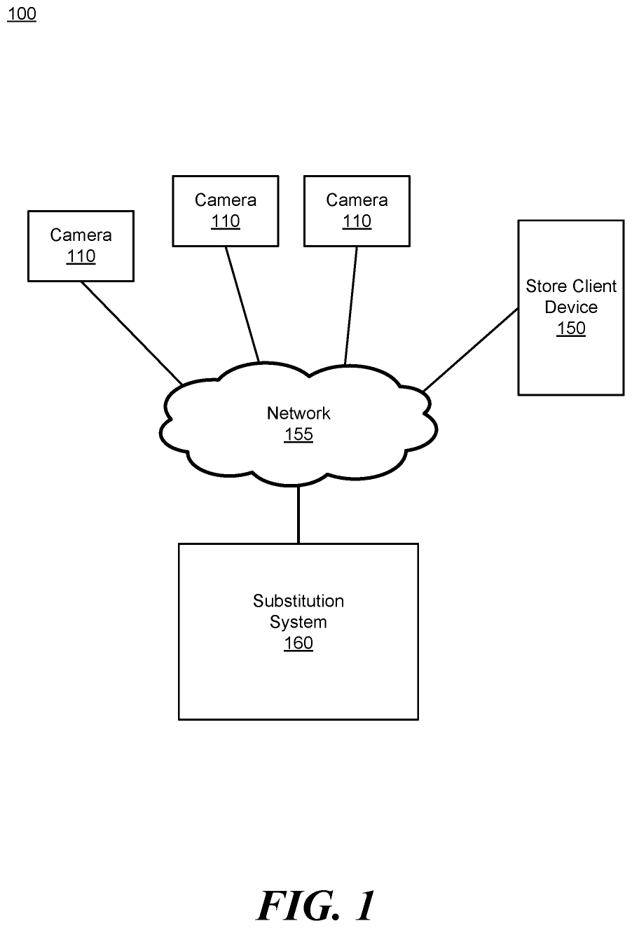

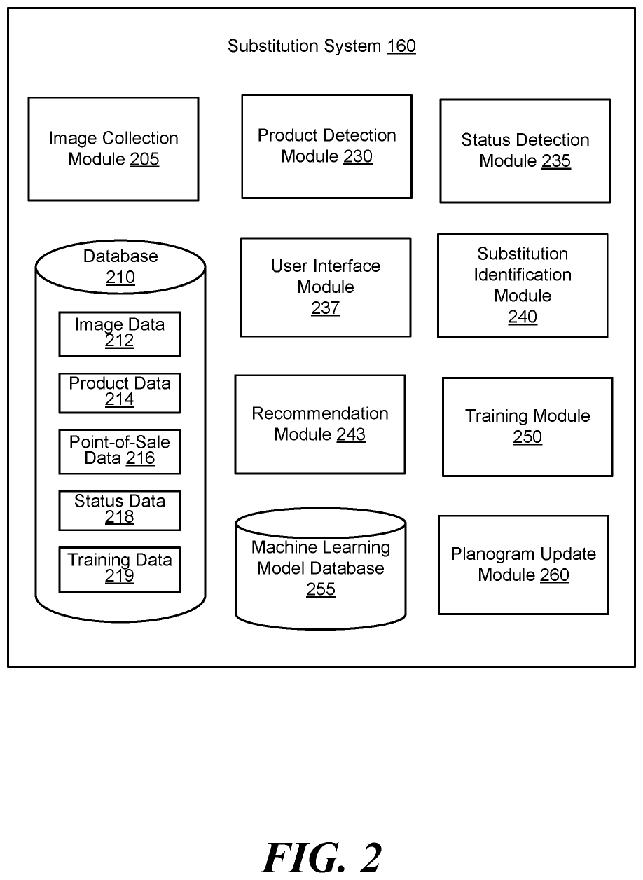

The substitution system 160, as illustrated in FIG. 2, includes an image collection module 205, a database 210, a product detection module 230, a status detection module 235, a user interface module 237, a substitution identification module 240, a recommendation module 243, a training module 250, a machine learning model database 255, and a planogram update module 260. The database 210 may include image data 212, product data 214, point of sale data 216, status data 218, and training data 219. Alternate embodiments may include more, fewer, or different components from those illustrated in FIG. 2, and the functionality of each component may be divided between the components differently from the description below. Additionally, each component may perform their respective functionalities in response to a request from a human, or automatically without human intervention.

The image collection module 205 collects images captured by the cameras 110 and, in some embodiments, by the store client device 150. For example, the captured images may include images of locations (e.g., respective portions of one or more shelves of an aisle of products in a store) of each of a plurality of products at a plurality of time intervals. The captured images may be stored as image data 212 in the database 210. The images for each location may be captured periodically or aperiodically. For example, the images may be captured by the cameras 110 every predetermined period of time (e.g., every minute, every hour, every 2-hours, every day, etc.), or aperiodically based on a trigger condition (e.g., based on a sensor detecting a removal of a product from a shelf, e.g., by a customer; based on a notification from a point of sale terminal of a sale of a product having a known shelf location, and the like). The image collection module 205 stores collected images and image labeling data in the database 210 as the image data 212. For example, the image collection module 205 may store as the image data 212 and for each image, a corresponding timestamp when the image was captured by the camera 110, identification information of the camera 110 that captured the image, and the like.

The database 210 stores data used by the substitution system 160. For example, the database 210 can store images from the camera 110 and the store client device 150 as the image data 212. The database 210 can also store location information associated with template images and can store products identified in images by the product detection module 230. The database 210 can also store product information, a store map or planogram, shopper information, or shopper location information.

The product detection module 230 detects one or more products in the captured images 212 collected by the image collection module 205. In some embodiments, the product detection module 230 identifies products in the image data 212 automatically. For example, the product detection module 230 may apply an optical character recognition (OCR) algorithm to the received images to identify text in the images and may determine which products are captured in the image based on the text (e.g., based on whether the text names a product, or a brand associated with the product). The product detection module 230 also may use a barcode detection algorithm to detect barcodes within the images and identify the products based on the barcodes. For example, store shelves may display a product label that contains a barcode or written numerical values that represent the stock keeping unit (SKU), for each product on the shelves, and the product detection module 230 may identify the product above each product label as the product associated with the barcode or SKU. Alternatively, the product detection module 230 detects products within the images by requesting that the store associate identify the products in the images using the store client device 150.

In some embodiments, the product detection module 230 uses a machine-learned product detection model to detect the products in the images. The product detection model can be trained based on template images that have been labeled by the store associate or other human labeler. In some embodiments, the product-detection model is trained based on labeled template images of the products offered for sale by the store. The product detection model identifies the products in the images aided by what the products should be in the images based on the planogram and camera ID associated with each image. In some embodiments, the product-detection model generates bounding boxes for each product (e.g., each SKU, each product ID, each product bar-code, each instance, or unit of each product, etc.), predicts the product in the bounding box, and determines a likelihood that the product-detection model's prediction is correct. The product-detection model can be a convolutional neural network that has been trained using labeled training data via Stochastic Gradient Descent based on the template images.

The status detection module 235 is configured to determine a status of each of a plurality of products detected by the product detection module 230. The status for a particular product detected by the product detection module 230 may indicate general inventory levels for the product (e.g., in stock, low stock, medium stock, out of stock, full stock, higher than a threshold stock, and the like) on the shelf. In some embodiments, the status detected by the status detection module 235 may convey more granular information about the inventory of the product such as a number of units of the product on the store shelf detected in the captured image, a metric (e.g., percentage) indicating the detected inventory level for the product in relation to total shelving capacity (e.g., as dictated by a planogram) for the product (e.g., where 0% indicates the product is out of stock on the store shelves, 100% indicates the product is in full stock or above a threshold level of stock, and the like). For each of the plurality of products detected by the product detection module 230, the status detection module 235 may detect the status at each of a plurality of time intervals. For example, the status detection module 235 may detect the status every time a new image is captured by the camera 110 and stored in the database 210 as the image data 212. As another example, the status detection module 235 may detect the status for each product based on another periodic (e.g., every hour, every 2-hours, every day, and the like) or aperiodic (e.g., based on a predetermined trigger condition) basis.

In some embodiments, the status detection module 235 may detect the status for each product at each time interval automatically. For example, the status detection module 235 detects the status using product data 214 and point-of-sale data 216 in the database 210. The product data 214 may include information related to the products being carried on the store shelves such as product identification information (e.g., UPC, bar code, and the like), inventory information (e.g., number of units of product known to be in stock), and the like. The point-of-sale data 216 may include information regarding a record of sales for each product included in the product data 214. For example, each time each unit of each product is sold (or otherwise is removed from being included in the product inventory information), the substitution system 160 may generate a data entry that corresponds to the record of sales for the product and that further includes additional information such as a timestamp for a time of sale for the product. The generated data entries comprising the record of sales for each of the plurality of products with corresponding timestamps for the time of sale may be stored as the point-of-sale data 216. The timestamp for each generated data entry may correspond to the time of sale of the product for the generated data entry. The record of sales for a given product may thus include, for example, a plurality of data entries respectively logging individual sales transactions corresponding to the given product and information associated with each transaction, e.g., time of sale, number of units (e.g., quantity) of the given product sold in the transaction, and the like. By interacting with the point-of-sale data 216, the substitution system 160 may thus be able to determine, e.g., a total number of units or quantity of a given product sold over a particular time period (e.g., during the last day, last hour, last week, last month, and the like), and further determine a rate (e.g., rate of sale; number of units or quantity sold per hour, per day, per week, and the like) at which the given product sold during the particular time period.

Based on the point-of-sale data 216 for a given product and further based on corresponding product data 214 (e.g., number of units of a product sold since a known quantity of units of the product were restocked on the store shelves at a known point in time) for the product, the status detection module 235 may be configured to determine for any point in time, the high-level or granular status for the product (e.g., whether the product is low in stock, medium stock, full stock, out of stock, whether the product is 30% in stock, 80% in stock, and the like).

In some embodiments, the status detection module 235 may be configured to determine the status for each of the plurality of products at each of the plurality of time intervals by using a machine learning model that detects the status using the image data 212. For example, the machine learning model may be configured to accept as input an image of a store shelf where a product is stocked, and configured to output a status (e.g., whether the product is low in stock, medium stock, full stock, out of stock, whether the product is 30% in stock, 80% in stock, and the like) of the product based on the input image. In some embodiments, the machine learning model (e.g., status detection model) of the status detection module 235 can be trained based on template images that have been labeled by the store associate or other human labeler. In some embodiments, the status detection model is trained based on labeled template images indicating the different levels of stock for the products offered for sale by the store. The status detection model may identify the status in the images aided by additional information such as the product data 214, the point-of-sale data 216, the planogram, the camera ID associated with each image, and the like. In some embodiments, the status detection model 235 generates bounding boxes for each product or each unit of each product, predicts the number of units for the product and determines a likelihood that the model's prediction is correct. The product-detection model can be a convolutional neural network that has been trained using labeled training data via Stochastic Gradient Descent based on the template images.

In some embodiments, the status detection module 235 may also detect empty portions of shelves or display areas within the store. The status detection module 235 may generate bounding boxes that identify portions of images received from the cameras 110 where a product is out of stock. While the bounding boxes may identify portions of images where a product is out of stock, the bounding boxes may not actually identify which product is out of stock. In some embodiments, the bounding boxes may also identify the product that is out of stock (e.g., based on barcodes or SKUs in the product labels adjacent to the corresponding empty portions of the store shelves). The bounding boxes may be generated using a machine-learned model that is trained based on template images of empty shelves or display areas within the store. The machine-learned model may also be trained based on template images with one or more stocked products as well.

The status detection module 235 uses products detected by the product detection module 230 to detect products that are out of stock in the received images. For example, the status detection module 235 may use the template images to determine which products are supposed to be detected in an image receive from a particular camera 110 based on the unique camera ID. Moreover, the status detection module 235 may determine which products are supposed to be detected in the image by identifying one or more template images that capture areas of the store that are captured by the received images. If the status detection module 235 determines that an item is not detected in the image received from the camera 110 that is supposed to be detected in the image, the status detection module 235 determines that the product is out of stock. The status detection module 235 may output the status of a product as being out of stock only when a shelf is completely empty. In another instance, if the training data may include labeling shelves that are out of stock when the shelves are mostly empty (e.g., have only one or two products on the shelf), then the model will tend to identify partly stocked products (or almost empty shelves) as out of stock. In some embodiments, multiple models are trained where one model detects empty shelves, and another model detects partly empty shelves. Additional operations associated with the image collection module 205, the product detection module 230, and the status detection module 235 are described in more detail in U.S. Pat. No. 10,949,799, issued Mar. 16, 2021 to Francois Chaubard and entitled “On-Shelf Image Based Out-of-Stock Detection,” which is herein incorporated by reference in its entirety.

In some embodiments, the status detection module 235 may further be configured to generate for each of the plurality of products detected by the product detection module 230 and for each of the plurality of time intervals, data entries comprising the status of the product and a timestamp indicating the time of the status. For example, the timestamp may correspond to the time the image, based on which the status is detected, was captured. As another example, the timestamp may correspond to a time of sale of a product as determined based on the point-of-sale data 216. The data entries generated by the status detection module 235 for the plurality of products for the plurality of time intervals may be stored in the database 210 as status data 218.

The user interface module 237 interfaces with the store client device 150. The user interface module 237 may receive and route messages between the substitution system 160, the cameras 110, and the store client device 150, for example, app-based notifications, system notifications, instant messages, queued messages (e.g., email), text messages, or short message service (SMS) messages. The user interface module 237 may provide application programming interface (API) functionality to send data directly to native client device operating systems, such as IOS®, ANDROID™, WEBOS®, or RIM®. The user interface module 237 generates graphical user interfaces, such as web pages, for the substitution system 160. The user interfaces may be displayed to the store associate through the store client device 150. The user interface module 237 configures a user interface based on the device used to present it. For example, a user interface for a smartphone with a touchscreen may be configured differently from a user interface for a web browser on a computer. Exemplary user interfaces that the user interface module 237 can provide to the store client device 150 include: an interface for capturing template images of store shelves that hold products for sale by the store, an interface to the store client device 150 for labeling products in template images, an interface for displaying images captured by the cameras 110 or by the store client device 150, an interface to display a planogram, an interface to display one or more recommendations regarding changing one or more parameters associated with one or more products based on operations performed by the substitution system 160, an interface to accept as input an identification of two or more products that are substitutions, an interface to display an updated planogram that is updated based on a generated recommendation, an interface to display one or more of the image data 212, the product data 214, the point-of-sale data 216, and the status data 218, and the like.

The substitution identification module 240 is configured to identify a plurality of products that are substitutions. As used herein, a “substitute” product identified by the substitution system 160 is a product that has an inverse correlation of sales to another product's stock rate. For example, the substitute product is a product that a customer may purchase instead of another product they originally intended to purchase but is unavailable (e.g., is out of stock). As another example, a customer coming to a store to buy a bottle of Coke may purchase Pepsi instead, if Coke bottles are out of stock on the store shelves. Alternatively, or in addition, a customer looking for a bottle of Pepsi may purchase Coke instead, if Pepsi bottles are out of stock on the store shelves. In either case, bottles of Coke and Pepsi are products that are substitutions within the meaning of this disclosure.

In some embodiments, the substitution identification module 240 identifies the plurality of products that are substitutions based on user input. For example, the substitution identification module 240 is configured to interact with the user interface module 237 to orchestrate an interface that is presented to a user of the store client device 150. The user may then interact with the interface to identify the plurality of products that are substitutions by providing an input on the interface that identifies two or more products as the plurality of products that are substitutions.

In some embodiments, the substitution identification module 240 identifies the plurality of products that are substitutions automatically. For example, the substitution identification module 240 may access the image data 212, the product data 214, the point-of-sale data 216, and the status data 218 corresponding to a predetermined period of time (e.g., for the last one week). The substitution identification module 240 may analyze the accessed data to identify a plurality of products (e.g., two, three, or more products) that are substitutions. In some embodiments, the accessed data may correspond to a category or sub-category of products carried by the store based on the store planogram or product taxonomy. For example, the substitution identification module 240 may identify a plurality of products that belong to a particular category or sub-category of products (e.g., carbonated beverages) as products that are candidates for substitutions. In this case, the accessed data may correspond to data associated with the identified plurality of products that are candidates for substitutions. As another example, the substitution identification module 240 may receive as input via the user interface module 237 an indication from a user of the store client device 150 indicating a plurality of products that are substitution candidates. For example, the user may specify a particular category or sub-category of products as substitution candidates.

The substitution identification module 240 may then access for each the plurality of products that are identified as the candidates for substitutions, the status data 218 to track a status of the product at each of a plurality of time intervals. The substitution identification module 240 may further access for each the plurality of products that are candidates for substitutions, the point-of-sale data 216 to track a record of sales for the product with corresponding timestamps for each time of sale. The data accessed by the substitution identification module 240 may correspond to a predetermined period of time (e.g., for the last one week). The accessed data may be processed or converted by the substitution identification module 240 to have a desired periodic or aperiodic frequency (e.g., hourly, daily, and the like).

The substitution identification module 240 may further generate tagged data based on the accessed status data 218 and the point-of-sale data 216. For example, for each the plurality of products that are candidates for substitutions and for each data entry related to each sale transaction of the product, the substitution identification module 240 may generate tagged data that associates the sale transaction having a particular corresponding timestamp with the status of each of the remaining ones of the plurality of products that are candidates for substitutions. The tagged status of each remaining product may be the status that is included in the status data 218 and that is associated with a time interval that corresponds to the particular corresponding timestamp of the sale transaction.

In some embodiments, the substitution identification module 240 uses a machine-learned model to detect the products that are substitutions within the substitution candidates. The substitution identification model can be trained based on historical labeled training data. The historical labeled training data may correspond to data of one or more stores in one or more geographic regions including or excluding the store for which the substitution identification module 240 is identifying the products that are substitutions. The historical data may include historical tagged data associating records of historical sales of products that are candidates for substitutions with corresponding contemporaneous historical status of each of remaining ones of the products that are candidates for substitutions, and historical feature data (e.g., labeled data identified by a human labeler) indicating products that are from among the products that are candidates for substitutions and that are actually identified as the substitutions. The substitution identification model can be trained based on additional features of the historical data. For example, the additional features may include corresponding weather data, event data (e.g., sporting event, other local event, public holiday event, etc.), demographic data, season data (e.g., winter, summer), time-of-week (e.g., weekday vs. weekend) data, and the like.

The substitution identification module 240 may input the tagged data for the plurality of products that are candidates for substitutions and corresponding to a predetermined time period (e.g., last one week) into the trained substitution identification model and receive as output from the machine learning model, a subset of products that are from among the plurality of products that are candidates for substitutions, the subset of products being the identified plurality of products (e.g., two or more products) that are substitutions. The model may thus uncover as substitutes two or more products that were previously unknown to be substitutes (e.g., discovering based on the data that when Coke goes out of stock, Mountain Dew sales go up). In identifying the plurality of products that are substitutions, the substitution identification module 240 may also input additional feature data (e.g., weather data, season data, event data, etc.) associated with the plurality of products that are candidates for substitutions. The model may thus be capable of identifying based on the data that, for example, during one period (e.g., one week in the summer) products A and B as substitutions, and that during a different period (e.g., one week in the winter) products A and C as substitutions. Substitutions identified by the substitution identification module 240 may be mapped to one another as substitutions and stored in a mapping table. For example, Coke and Pepsi may be mapped to one another as substitutions by substitution identification module 240 and stored in the mapping table. The substitution mapping may have a validity period. For example, the products that have been identified as substitutions may be treated as substitutions for an upcoming preset period of time. A rolling window of recent data (e.g., data captured every minute for the last 30 minutes) may be used to periodically update the substitution mapping, identify new mappings, remove old, outdated mappings, etc. Remapping substitutions periodically ensures that the predictions output from a machine learning model of the recommendation module 243, based on which inventory management decisions are made (e.g., restocking rate or quantity, reorder rate or quantity, etc.) remain accurate and current in changing times. The substitution system 160 is thus an agile, data-driven system that continuously captures and responds to changing patterns of customer behavior and stock availability, thereby increasing inventory management efficiency, reducing costs, and increasing profits.

The recommendation module 243 generates a recommendation pertaining to changing one or more parameters associated with one or more of the products that are identified as substitutions by the substitution identification module 240. In some embodiments, the recommendation module 240 may identify the recommendations based on an output of a machine learning model indicating what quantity of demand of a particular product that is out of stock transfers to a known substitute product that is in stock. For example, for each of the plurality of products that are identified as substitutions by the substitution identification module 240, the recommendation module 243 may access the point-of-sale data 216 and the status data 218 corresponding to a predetermined period of time (e.g., for the last one week). The recommendation module 243 may analyze the accessed data to determine (e.g., using one or more machine learning models) the likelihood of transfer of demand between products that are substitutions, based on the status of the products and the rate of sales of the products during a given time period. Based on the determination, the recommendation module 243 may further generate recommendations pertaining to changing one or more parameters associated with one or more of the products.

The recommendations may be generated based on an algorithm or other predetermined rule base or logic engine dictating what recommendations to surface based on the output from the machine learning model providing a quantified metric of how much demand is predicted to transfer from one or more (out of stock) products to another.

For example, the recommendation machine learning model may be trained based on a comparison a rate of sale of a product when its identified substitute product is in stock to a rate of sale of the product when its identified substitute product is out of stock. Based on the comparison, the recommendation model may learn weights that may predict how much a rate of sale (e.g., number of units or quantity of the product sold per unit time) of the product is affected by the stock status (e.g., in stock, medium stock, low stock, out of stock, and the like) of each of its identified substitute(s). A rolling window of most recent or other desired period of data may be used in training the model to learn the weights based on which the prediction indicating how much demand will transfer is made. The demand transfer prediction from the model may account for additional features in addition to rate of sale of the substitute and the stock status of the product. The recommendation module 243 may include logic to output recommendations to change parameters (e.g., reorder rate, restocking rate) associated with the product (or its identified substitute product(s)) based on the predicted demand transfer metric.

The machine learning model of the recommendation module 243 may be trained using historical labeled training data. The historical labeled training data may correspond to data of one or more stores in one or more geographic regions including or excluding the store for which the recommendation module 243 is generating the recommendations. The historical data may include a rolling window of historical record of sales data of a given product that is labeled with contemporaneous historical status data indicating the status of one or more other products that have been identified as being substitutions of the given product by the substitution identification module 240. For example, the point-of-sale data 216 including a record of sales of the given product may be associated with the status data 218 for a particular substitute product by correlating each sale transaction for the given product with the status of the substitute product at the time of the sale of the given product. The model may then be trained using the correlated data to determine how the rate of sales of the given product changes based on substitute product's status. The model may be retrained on a periodic basis based on the rolling window of data.

The recommendation model can be trained based on additional features of the historical data. For example, the additional features may include corresponding weather data, event data (e.g., sporting event, other local event, public holiday event, etc.), demographic data, season data (e.g., winter, summer), time-of-week (e.g., weekday vs. weekend) data, and the like. For two products that are identified as substitutions by the substitution identification module 240, the rate of substitution for a first product based on the stock status of the second product may be different from a rate of substitution of the second product based on the stock status of the first product. For this reason, a recommendation model may be trained separately for each of the products that are substitutions based on the rate of sales of that product tagged with the status of its identified substitutes.

The substitution data identified for a given product using the substitution identification model can be used as an additional input in the recommendation model for the given product. The recommendation model may then take as inputs the current status of the substitutes of a given product and may output a prediction of a change in rate of sales for the given product for a given time period on that basis. This prediction may feed into any other process disclosed herein (e.g., a need to restock Coke faster given that the rate of sales of Coke is expected to increase in the next time period; a need to order more Coke from a third-party vendor; update planogram; maintain out of stock status for Pepsi for the upcoming time period; etc.).

The one or more parameters whose change is recommended by the recommendation module 243 may correspond to any of the products that are substitutions. For example, in a case where two products are identified as substitutions and a first product is out of stock, the one or more parameters whose change is recommended by the recommendation module 243 may be associated with the first product. Alternately, or in addition, the one or more parameters whose change is recommended by the recommendation module 243 may be associated with the second product.

The one or more parameters may include a restocking metric. For example, the restocking metric may be a rate at which a particular product is restocked on the store shelves (e.g., number of times per unit time the product is restocked (e.g., every 12-hours, every 24-hours, every week, and the like, stop restocking product for a given time period, etc.). As another example, the restocking metric may be a quantity of the particular product that is restocked on the store shelves (e.g., number of units of the product to be restocked at-a-time). The one or more parameters may include a reorder metric. For example, the reorder metric may be a rate at which a particular product is reordered from a third-party vendor (e.g., number of times per unit time the product is reordered from a third-party vendor (e.g., every day, every other day, every week, every month, and the like; stop reordering product for a given time period; etc.). As another example, the reorder metric may be a quantity of the particular product that is reordered from the third-party vendor (e.g., number of units of the product to be reordered from the third-party vendor at-a-time). The one or more parameters may include a restocking priority order. For example, the restocking priority order may dictate the order in which a store associate is to restock the particular product (e.g., restock product X first before restocking other products).

For example, consider a case where a store expects 100 units each of product A and B to sell in an upcoming week in a given store. Further, assume that the products A and B are identified as being substitutions by the substitution system 160, and the recommendation model has determined that 100% of the demand for product A is likely to transfer to product B when the product A is out of stock. In this case, recommendation engine of the recommendation module 243 may dictate that one or more parameters (e.g., restocking rate, restocking quantity, reorder rate, reorder quantity, restocking priority order, etc.) for product B may be updated so that 200 units of the product B are available for the upcoming week in light of the anticipated increase in demand for product B. Further, in this case, the rule or logic of the recommendation module 243 may dictate that since 100% of the demand for product A is likely to transfer to product B, one or more parameters (e.g., restocking rate, restocking quantity, reorder rate, reorder quantity, restocking priority order, etc.) for product A be updated to reflect that Product A need not be carried by the store for the upcoming week.

In the above example, assume that the machine learning model outputs that 30% of the demand for product A is likely to transfer to product B when the product A is out of stock. In this case, the recommendation engine of the recommendation module 243 may dictate that one or more parameters (e.g., restocking rate, restocking quantity, reorder rate, reorder quantity, restocking priority order, etc.) for product B may be updated so that 130 units of the product B are available for the upcoming week in light of the anticipated increase in demand for product B.

The recommendation module 243 may further include functionality to interact with the user interface module 237 to present the generated recommendations pertaining to changing the one or more parameters of one or more of the products that are substitutions via a user interface to a user of the store client device 150 for consideration. In some embodiments, the recommendation module 243 may include additional functionality to automatically implement one or more generated recommendations without any human intervention. For example, when predetermined conditions are met, and based on the output from the machine learning model, the recommendation module 243 may automatically perform actions like update the planogram and instruct a store associate to take necessary steps to implement the updated planogram on the store shelves, change the restocking rate or quantity for a particular product and instruct an associate to carry out the restocking operation, change the reorder rate or quantity for a particular product and transmit an updated order to a third party vendor for the updated reorder rate or quantity, change a restocking priority order and instruct a store associate to implement the changed priority order to ensure a predetermined product remains available on the shelf despite the anticipated increase in demand of the product due to transfer of demand from another product that is identified by the substitution system 160 as a substitution.

The training module 250 trains one or more machine learning models stored in machine learning model database 255 to output information regarding products that are substitutions and further output recommendations pertaining to one or more parameters associated with one or more of the products that are substitutions. The machine learning models may be supervised or unsupervised models. For supervised learning, the database 210 may store training data 219. The training data 219 may include labeled data for product detection by the product detection module 230, labeled data for status detection by the status detection module 235, labeled data for substitution identification by the substitution identification module 240, recommendation generation by the recommendation module, and the like. For example, the training data 219 may include labeled template images of the products offered for sale by the store, labeled template images indicating the different levels of stock for the products offered for sale by the store, labeled template images of empty shelves or display areas within the store, labeled template images with one or more stocked products as well, and the like. As another example, the labeled training data 219 may include historical data associated with product substitution candidates that were identified as substitutions. In some embodiments, the historical data may be historical tagged data associating records of historical sales of products that are candidates for substitutions with corresponding contemporaneous historical status of each of remaining ones of the products that are candidates for substitutions, and historical feature data indicating products that are from among the products that are candidates for substitutions and that are actually identified as the substitutions. As another example, the labeled training data 219 may include historical data associated with measured changes in rate of sales of a product in historical time periods that are tagged with corresponding historical status information of one or more known substitute products. The historical data may further include data of additional contemporaneous features like weather data, event data (e.g., sporting event, other local event, public holiday event, etc.), demographic data, season data (e.g., winter, summer), time-of-week (e.g., weekday vs. weekend) data, and the like.

The machine learning model database 255 stores a plurality of machine learning models trained using the training module 250. The plurality of machine learning models may be implemented using a variety of types of machine-learned models or trainable networks. For example, the machine learning models may be a neural network, decision tree, or other type of computer model, and any combination thereof. In one embodiment, at least some of the computation to train the models occurs locally on the substitution system 160 itself that includes a relatively small deep learning neural network. Then, a larger amount of the computation would happen on a server. Accordingly, in one embodiment, an additional portion of the computation could happen in the cloud via a back end of the substitution system 160.

The planogram update module 260 is configured to generate an updated planogram based on the recommendations generated by the recommendation module 243. For example, based on the recommended changes to the one or more parameters associated with the product, the planogram update module 260 may generate the updated planogram that includes one or more recommended changes, and the planogram update module 260 may further interact with the user interface module 237 to transmit and present the updated planogram to the store client device 150. For example, the recommendation may be to increase the restocking quantity of the particular product on the store shelves such that the planogram may be affected to create room on the store shelves for the increased quantity of the particular product. In this case, the planogram update module 260 may update the planogram to reflect this change (e.g., by reducing the quantity of another product on the shelf) and present the updated planogram as a recommendation to a user of the store client device 150.

### Example Substitution Identification Operation and Parameter Change Recommendation Operation

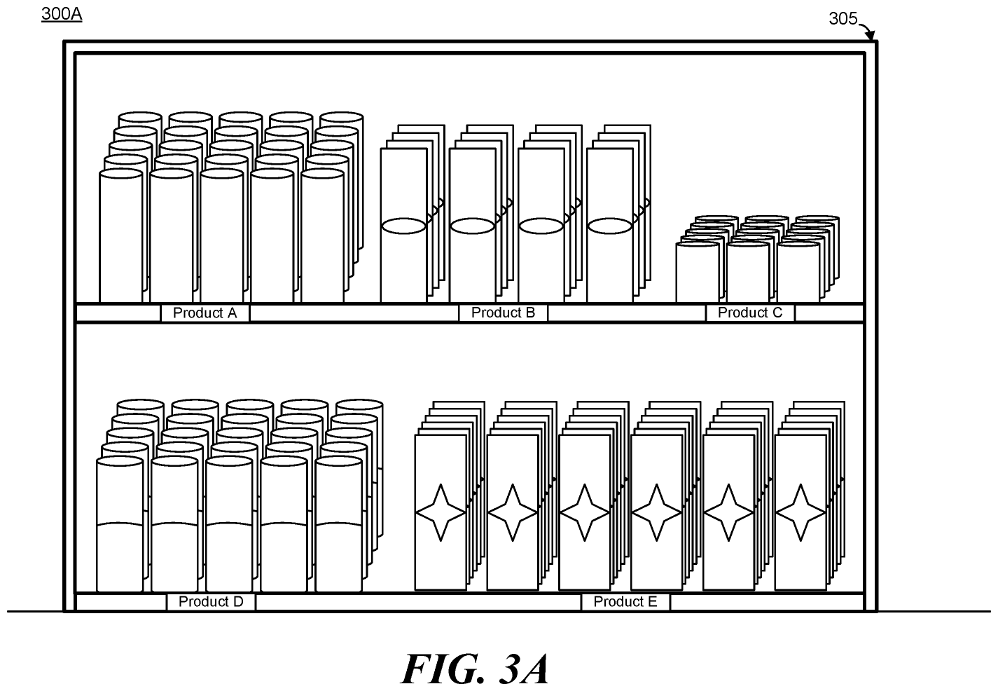

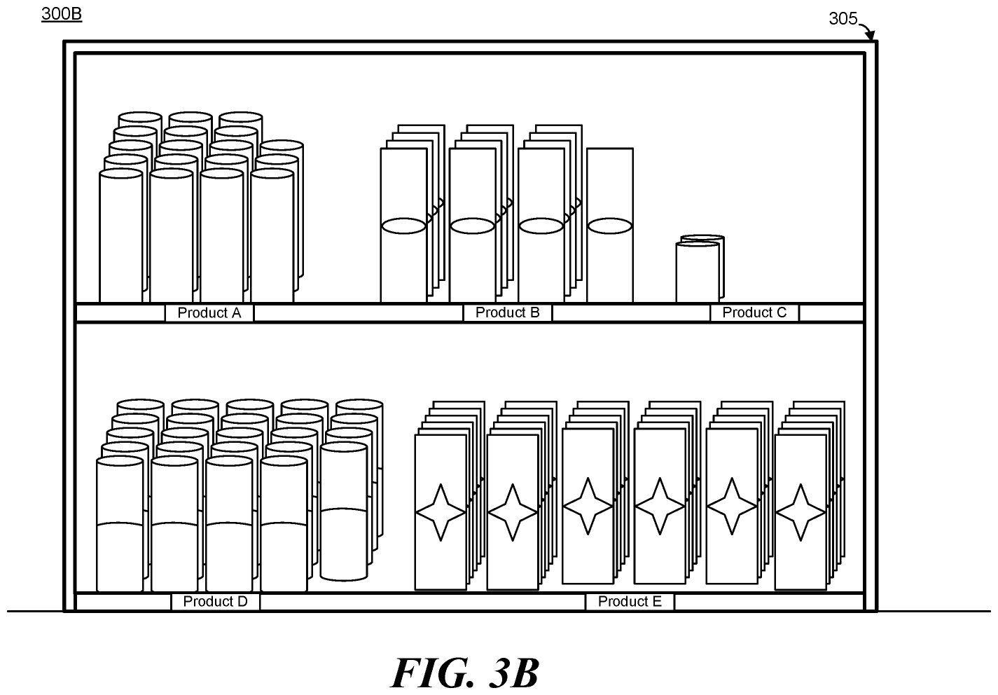

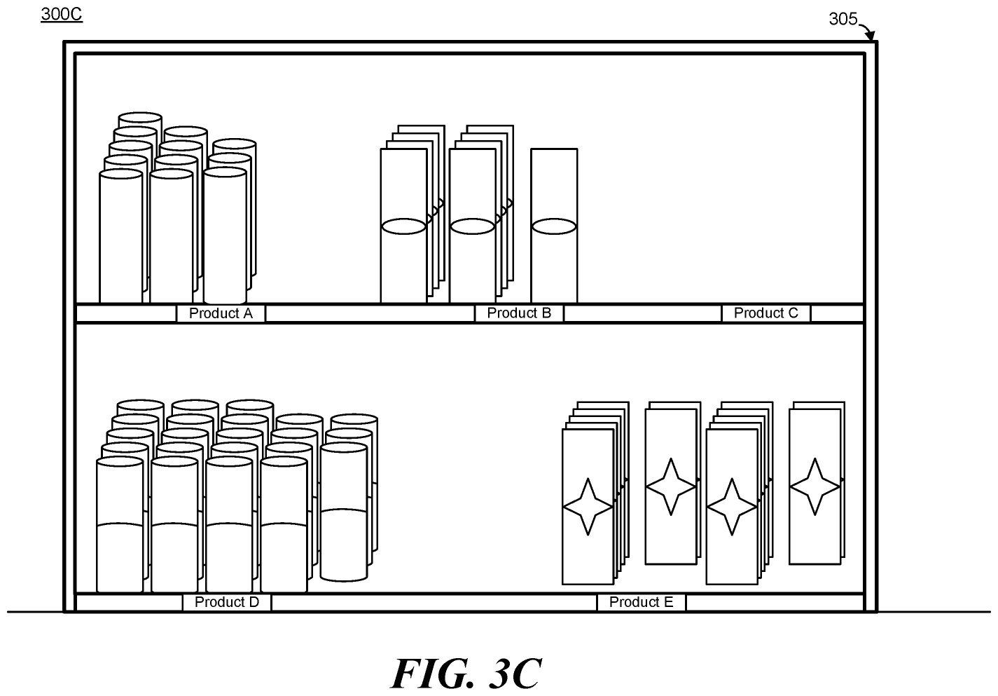

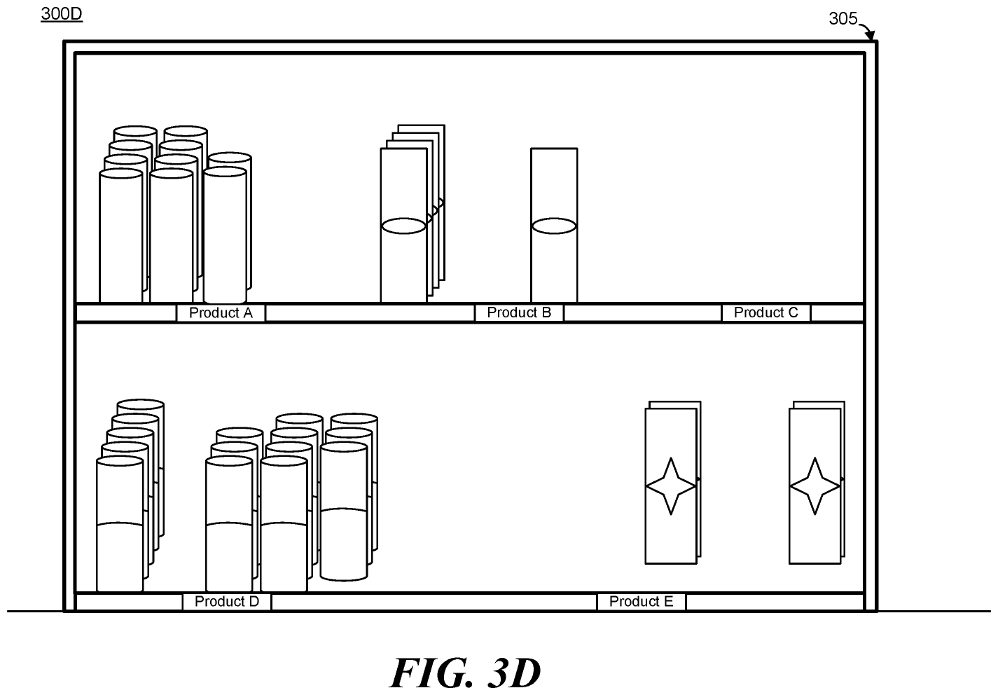

FIGS. 3A-3D illustrate a depiction of time-series image data of a store shelf, in accordance with some embodiments. In some embodiments, the substitution system 160 may identify a plurality of products that are substitutions based on the time-series image data. Further, in some embodiments, the substitution system 160 may generate recommendations pertaining to one or more parameters associated with one or more products that are substitutions, based on the time-series data.

FIG. 3A illustrates a captured image 300A of a state where five different products (Product A, Product B, Product C, Product D, and Product E) are in-stock on a store shelf 305. The store shelf 305 may correspond to a particular category or sub-category of products in a store according to a product taxonomy or the planogram that is predetermined for the store. For example, the store shelf 305 shown in FIGS. 3A-3D may correspond to a “carbonated beverages” sub-category of products. In the example shown in the figures, five different types of carbonated beverages (Products A-E) are carried by the store in the store shelf 305. Further, based on the planogram (e.g., information indicating the expected demand for each of the Products A-E), a different number of units for each of the products may be carried on the shelf 305 and a different amount of space may be allotted for carrying each product on the shelf 305.

In the example shown in FIG. 3A, there are 25 units of Product A, 16 units of Product B, 15 units of Product C, 25 units of Product D, and 36 units of Product E on the shelf 305. The number of units for each product on the shelf 305 may be dictated by the planogram of the store, and store associates may manually restock the products based on a predetermined plan. Each image 300 (300A, 300B, 300C, 300D) of each of FIGS. 3A-3D may be captured at a respective point in time, and the status detection module 235 may perform operations on the image 300 to detect a corresponding status for each of the products A-E at respective time intervals corresponding to capture times of the image 300. Thus, for example, the status detection module 235 may detect for time T1 corresponding to image 300A of FIG. 3A that there are 25 units of Product A, 16 units of Product B, 15 units of Product C, 25 units of Product D, and 36 units of Product E on the shelf 305. The status detection module 235 may further detect for time T2 corresponding to image 300B of FIG. 3B, there are 18 units of Product A, 13 units of Product B, 2 units of Product C, 24 units of Product D, and 33 units of Product E on the shelf 305, and so on. The status detection module 235 may store the detections as the status data 218.

Further, the substitution system 160 may access the point-of-sale data 216 indicating a record of sales for each product A-E including a timestamp for each sale. The substitution identification module 240 may analyze the accessed data (e.g., status data corresponding to FIGS. 3A-3C, and corresponding contemporaneous record of sales data) to identify that Products C and E are substitutions (e.g., subset of products of the plurality of products that are candidates for substitutions). For example, the substitution identification module 240 may tag each sale of each unit of Product E during time period T1-T3 of FIGS. 3A-3C with a status (e.g., in stock, low stock, out of stock, etc.) of each of the other substitution candidate products A, B, C, and D, and input the tagged data into a machine learned model. The substitution identification model may identify a trend as shown in FIGS. 3A-3C where after Product C went out of stock between times T2 and T3, the rate of sales of Product E went up significantly (e.g., only 3 units of Product E sold between times T1 and T2, whereas 19 units of Product E sold between times T2 and T3). The machine learning model may be trained to detect a correlation when a rate of sale of a product increases beyond a predetermined threshold in conjunction with an out of stock or low stock status of another product and output a probability indicating a likelihood that the detected correlated products are substitutions. The likelihood may be higher depending on the rate of increase in the rate of sale, and the number of instances where such a correlation between the two products is detected. The correlation may also be detected both ways because while demand for one product may increase when another is out of stock may not necessarily mean that the demand for the other product will increase when the one product is out of stock. Thus, based on the data and machine learning model outputs corresponding to FIGS. 3A-3C, the substitution identification module 240 may identify Products C and E as substitutions. In another example, based on the data and machine learning model outputs corresponding to FIGS. 3A-3C, the substitution identification module 240 may identify Products A, C and E as substitutions.

Further, as shown in FIG. 3D, at time T3, the system may collect additional status data and also collect corresponding point-of-sale data corresponding to the plurality of products. Further, based on the data and machine learning model outputs corresponding to FIGS. 3A-3D, the recommendation module 243 may be configured to output a prediction of the change in demand for Product E in an upcoming time period and generate recommendation pertaining to one or more parameters of, e.g., Product E, based on the prediction. For example, based on a comparison of the rate of sales of the Product E before the time when Product C went out of stock with a comparison of the rate of sales of the product E after the time when Product C went out of stock, the machine learning model may output a prediction that in an upcoming time period (and while Product C is out of stock) the demand for product E will increase by 75%. Based on this output from the model, the recommendation module 243 may apply predetermined logic to recommend one or more parameter changes. For example, the recommendation module 243 may recommend that number units of Product E to be restocked at-a-time on the shelves 305 be changed from 36 to 63 to account for the anticipated 75% increase in demand for Product E.

### Example Process

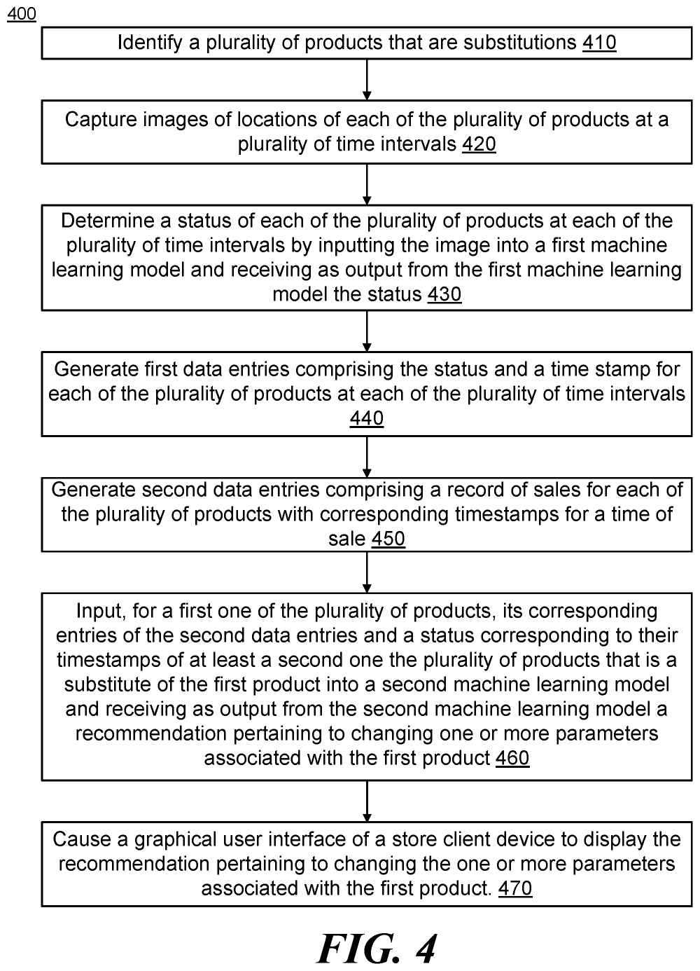

FIG. 4 illustrates an exemplary process 400 for managing inventory for products that are identified as substitutions by the substitution system 160, in accordance with some embodiments. The process 400 illustrated in FIG. 4 starts with the substitution identification module 240 identifying 410 a plurality of products that are substitutions (e.g., products C and E in FIGS. 3A-3C). Cameras 110 may capture 420 images (e.g., images 300A-D of FIGS. 3A-3D) of locations of each of the plurality of products at a plurality of time intervals (e.g., times T1-T4 in FIGS. 3A-3D). The status detection module 235 may determine 430 a status of each of the plurality of products at each of the plurality of time intervals by inputting the image into a first machine learning model (e.g., status detection model of status detection module 235) and receiving as output from the first machine learning model the status (e.g., low stock, out of stock, etc.). The status detection module 235 may generate 440 first data entries (e.g., status data 218) comprising the status and a time stamp for each of the plurality of products at each of the plurality of time intervals. The substitution system 160 may generate 450 second data entries (e.g., point-of-sale data 216) comprising a record of sales for each of the plurality of products with corresponding timestamps for a time of sale. The recommendation module 243 may input 460, for a first one of the plurality of products (e.g., Product E in FIG. 3D), its corresponding entries of the second data entries and a status corresponding to their timestamps of at least a second one the plurality of products (e.g., Product C in FIG. 3D) that is a substitute of the first product into a second machine learning model (e.g., machine learning model of recommendation module 243) and receiving as output from the second machine learning model a recommendation pertaining to changing one or more parameters (e.g., reorder metric, restocking metric, etc.) associated with the first product. The user interface module 237 cause 470 a graphical user interface of the store client device 150 to display the recommendation pertaining to changing the one or more parameters associated with the first product.

### Example Computer System

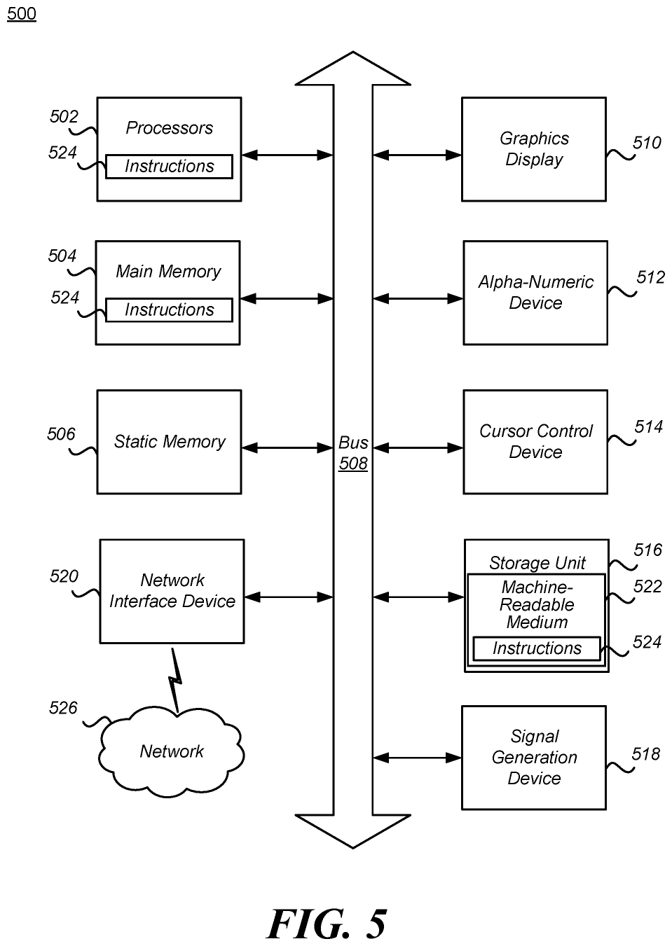

FIG. 5 is a block diagram illustrating components of an example computing machine that is capable of reading instructions from a computer-readable medium and execute them in a processor (or controller). A computer described herein may include a single computing machine shown in FIG. 5, a virtual machine, a distributed computing system that includes multiples nodes of computing machines shown in FIG. 5, or any other suitable arrangement of computing devices.

By way of example, FIG. 5 shows a diagrammatic representation of a computing machine in the example form of a computer system 500 within which instructions 524 (e.g., software, source code, program code, bytecode, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 5 may correspond to any software, hardware, or combined components shown in FIGS. 1-4 including but not limited to the substitution system 160, the store client device 150, the cameras 110, process 400, and various layers, modules, components, engines, and databased shown in the figures. While FIG. 5 shows various hardware and software elements, each of the components described in figures may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 524 that specify actions to be taken by that machine. Further, while only a single machine is illustrated, the term “machine” and “computer” may also be taken to include any collection of machines that individually or jointly execute instructions 524 to perform any one or more of the methodologies discussed herein.

The example computer system 500 includes one or more processors 502 such as a CPU (central processing unit), a GPU (graphics processing unit), a TPU (tensor processing unit), a DSP (digital signal processor), a system on a chip (SOC), a controller, a state machine, an application-specific integrated circuit (ASIC), a field-programmable gate array (FPGA), or any combination of these. Parts of the computing system 500 may also include a memory 504 that store computer code including instructions 524 that may cause the processors 502 to perform certain actions when the instructions are executed, directly or indirectly by the processors 502. Instructions can be any directions, commands, or orders that may be stored in different forms, such as equipment-readable instructions, programming instructions including source code, and other communication signals and orders. Instructions may be used in a general sense and are not limited to machine-readable codes.

One and more methods described herein improve the operation speed of the processors 502 and reduces the space required for the memory 504. For example, the methods described herein reduce the complexity of the computation of the processors 502 by applying one or more novel techniques that simplify the steps in training, reaching convergence, and generating results of the processors 502. The algorithms described herein also reduces the size of the models and datasets to reduce the storage space requirement for memory 504.

The performance of certain of the operations may be distributed among the more than processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations. Even though in the specification or the claims may refer some processes to be performed by a processor, this should be construed to include a joint operation of multiple distributed processors.

The computer system 500 may include a main memory 504, and a static memory 506, which are configured to communicate with each other via a bus 508. The computer system 500 may further include a graphics display unit 510 (e.g., a plasma display panel (PDP), a liquid crystal display (LCD), a projector, or a cathode ray tube (CRT)). The graphics display unit 510, controlled by the processors 502, displays a GUI (GUI) to display one or more results and data generated by the processes described herein. The computer system 500 may also include an alphanumeric input device 512 (e.g., a keyboard), a cursor control device 514 (e.g., a mouse, a trackball, a joystick, a motion sensor, or another pointing instrument), a storage unit 516 (a hard drive, a solid state drive, a hybrid drive, a memory disk, etc.), a signal generation device 518 (e.g., a speaker), and a network interface device 520, which also are configured to communicate via the bus 508.

The storage unit 516 includes a computer-readable medium 522 on which is stored instructions 524 embodying any one or more of the methodologies or functions described herein. The instructions 524 may also reside, completely or at least partially, within the main memory 504 or within the processor 502 (e.g., within a processor's cache memory) during execution thereof by the computer system 500, the main memory 504 and the processor 502 also constituting computer-readable media. The instructions 524 may be transmitted or received over a network 526 via the network interface device 520.

While computer-readable medium 522 is shown in an example embodiment to be a single medium, the term “computer-readable medium” should be taken to include a single medium or multiple media (e.g., a centralized or distributed database, or associated caches and servers) able to store instructions (e.g., instructions 524). The computer-readable medium may include any medium that is capable of storing instructions (e.g., instructions 524) for execution by the processors (e.g., processors 502) and that causes the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for benchmarking, grouping, and recommending CSP shapes through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
identifying a plurality of products that are substitutions;
capturing images of locations of each of the plurality of products at a plurality of time intervals;
determining a status of each of the plurality of products at each of the plurality of time intervals by inputting a captured image into a first machine learning model and receiving as output from the first machine learning model the status;
generating first data entries comprising the status and a timestamp for each of the plurality of products at each of the plurality of time intervals;
generating second data entries comprising a record of sales for each of the plurality of products with corresponding timestamps for a time of sale;
inputting, for a first one of the plurality of products, its corresponding entries of the second data entries and a status corresponding to their timestamps of at least a second one the plurality of products that is a substitute of the first product into a second machine learning model and receiving as output from the second machine learning model a recommendation pertaining to changing one or more parameters associated with the first product; and
causing a graphical user interface of a store client device to display the recommendation pertaining to changing the one or more parameters associated with the first product.

2. The method of claim 1, further comprising:
inputting, for the second product, its corresponding entries of the second data entries and a status corresponding to their timestamps of at least the first product into the second machine learning model and receiving as output from the second machine learning model a recommendation pertaining to changing one or more parameters of the second product.

3. The method of claim 1, wherein the recommendation pertaining to changing the one or more parameters associated with the first product includes changing at least one of:
a restocking metric for the first product; and
a reorder metric for the first product.

4. The method of claim 1, wherein the recommendation pertaining to changing the one or more parameters associated with the first product includes changing at least one of:
a restocking metric for the second product; and
a reorder metric for the second product.

5. The method of claim 1, wherein the recommendation pertaining to changing the one or more parameters associated with the first product includes:
generating an updated planogram that includes one or more recommended changes to a planogram; and
transmitting the updated planogram to a store client device.

6. The method of claim 1, wherein identifying the plurality of products that are substitutions comprises:
receiving user input that identifies two or more products as the plurality of products that are substitutions.

7. The method of claim 1, wherein identifying the plurality of products that are substitutions comprises:
identifying a plurality of products that are candidates for substitutions;
tracking, for each the plurality of products that are candidates for substitutions, a status of the product at each of a plurality of time intervals, and a record of sales for the product with corresponding timestamps for each time of sale;
generating, for each the plurality of products that are candidates for substitutions and for each time of sale for the product, tagged data that associates the sale of the product with the status of each of remaining ones of the plurality of products that are candidates for substitutions, the status corresponding to the timestamp for the time of sale of the product; and
inputting the tagged data for the plurality of products that are candidates for substitutions and corresponding to a predetermined time period into a third machine learning model and receiving as output from the third machine learning model, a subset of products from among the plurality of products that are candidates for substitutions, the subset of products being the identified plurality of products that are substitutions.

8. The method of claim 7, wherein the third machine learning model is trained using historical tagged data associating records of sales of products that are candidates for substitutions with corresponding contemporaneous historical status of each of the remaining ones of the products that are candidates for substitutions, and label data indicating products that are from among the products that are candidates for substitutions and that are identified as the substitutions.

9. The method of claim 1, wherein the second machine learning model is trained using historical record of sales data of the first product that is labeled with contemporaneous historical status data indicating the status of the second product.

10. The method of claim 1, wherein the corresponding entries of the second data entries for the first product that are input into the second machine learning model are entries that correspond to a predetermined time period.

11. A non-transitory computer-readable storage medium comprising memory with executable computer instructions encoded thereon that, when executed by one or more processors, cause the one or more processors to perform operations, the instructions comprising instructions to:
identify a plurality of products that are substitutions;
capture images of locations of each of the plurality of products at a plurality of time intervals;
determine a status of each of the plurality of products at each of the plurality of time intervals by inputting a captured image into a first machine learning model and receiving as output from the first machine learning model the status;
generate first data entries comprising the status and a timestamp for each of the plurality of products at each of the plurality of time intervals;
generate second data entries comprising a record of sales for each of the plurality of products with corresponding timestamps for a time of sale;
input, for a first one of the plurality of products, its corresponding entries of the second data entries and a status corresponding to their timestamps of at least a second one the plurality of products that is a substitute of the first product into a second machine learning model and receiving as output from the second machine learning model a recommendation pertaining to changing one or more parameters associated with the first product; and
cause a graphical user interface of a store client device to display the recommendation pertaining to changing the one or more parameters associated with the first product.

12. The non-transitory computer-readable storage medium of claim 11, further comprising:
inputting, for the second product, its corresponding entries of the second data entries and a status corresponding to their timestamps of at least the first product into the second machine learning model and receiving as output from the second machine learning model a recommendation pertaining to changing one or more parameters of the second product.

13. The non-transitory computer-readable storage medium of claim 11, wherein the recommendation pertaining to changing the one or more parameters associated with the first product includes changing at least one of:
a restocking metric for the first product; and
a reorder metric for the first product.

14. The non-transitory computer-readable storage medium of claim 11, wherein the recommendation pertaining to changing the one or more parameters associated with the first product includes:
generating an updated planogram that includes one or more recommended changes to a planogram; and
transmitting the updated planogram to a store client device.

15. The non-transitory computer-readable storage medium of claim 11, wherein identifying the plurality of products that are substitutions comprises:
receiving user input that identifies two or more products as the plurality of products that are substitutions.

16. The non-transitory computer-readable storage medium of claim 11, wherein identifying the plurality of products that are substitutions comprises:
identifying a plurality of products that are candidates for substitutions;
tracking, for each the plurality of products that are candidates for substitutions, a status of the product at each of a plurality of time intervals, and a record of sales for the product with corresponding timestamps for each time of sale;
generating, for each the plurality of products that are candidates for substitutions and for each time of sale for the product, tagged data that associates the sale of the product with the status of each of remaining ones of the plurality of products that are candidates for substitutions, the status corresponding to the timestamp for the time of sale of the product; and
inputting the tagged data for the plurality of products that are candidates for substitutions and corresponding to a predetermined time period into a third machine learning model and receiving as output from the third machine learning model, a subset of products from among the plurality of products that are candidates for substitutions, the subset of products being the identified plurality of products that are substitutions.

17. The non-transitory computer-readable storage medium of claim 16, wherein the third machine learning model is trained using historical tagged data associating records of sales of products that are candidates for substitutions with corresponding contemporaneous historical status of each of the remaining ones of the products that are candidates for substitutions, and label data indicating products that are from among the products that are candidates for substitutions and that are identified as the substitutions.

18. The non-transitory computer-readable storage medium of claim 11, wherein the second machine learning model is trained using historical record of sales data of the first product that is labeled with contemporaneous historical status data indicating the status of the second product.

19. The non-transitory computer-readable storage medium of claim 11, wherein the corresponding entries of the second data entries for the first product that are input into the second machine learning model are entries that correspond to a predetermined time period.

20. A computing system comprising:
a processor; and
a non-transitory computer-readable storage medium storing instructions for managing substitutions, the instructions when executed by the processor cause the processor to perform steps including:
identifying a plurality of products that are substitutions;
capturing images of locations of each of the plurality of products at a plurality of time intervals;
determining a status of each of the plurality of products at each of the plurality of time intervals by inputting a captured image into a first machine learning model and receiving as output from the first machine learning model the status;
generating first data entries comprising the status and a timestamp for each of the plurality of products at each of the plurality of time intervals;
generating second data entries comprising a record of sales for each of the plurality of products with corresponding timestamps for a time of sale;
inputting, for a first one of the plurality of products, its corresponding entries of the second data entries and a status corresponding to their timestamps of at least a second one the plurality of products that is a substitute of the first product into a second machine learning model and receiving as output from the second machine learning model a recommendation pertaining to changing one or more parameters associated with the first product, and
causing a graphical user interface of a store client device to display the recommendation pertaining to changing the one or more parameters associated with the first product.
